(19) United States
(12) Patent Application Publication
(10) Pub. No.: US 2009/0300272 A1
(43) Pub. Date: Dec. 3, 2009

(54) Method for increasing reliability of data accessing for a multi-level cell type non-volatile memory

(75) Inventor: Chanson Lin, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Afa Technology, Inc., Hsinchu (TW)

(21) Appl. No.: 12/230,661

(22) Filed: Sep. 3, 2008

(30) Foreign Application Priority Data
May 30, 2008 (TW) 097120212

(51) Int. Cl. G06F 12/02

(52) U.S. Cl. 711/103; 711/E12.008

(57) ABSTRACT

A method for increasing reliability of data accessing for a multi-level cell type non-volatile memory, wherein a plurality of data storage blocks are taken for data accessing of a computer system in accordance with the structure of storage of the multi-level cell type non-volatile memory; and a page jumper is provided to select at least a set of data storage pages in corresponding to a physical page of same storage cell, by jump connecting of the page jumper which jumps over another data storage page in corresponding to the physical page of the same storage cell, then the data storage page selected is accessed for at least a data storage block. the frequency of erasing of flash memory blocks can thus be reduced to elongate the life of use of the multi-level cell type non-volatile memory, this can assure integrity of the data in accessing during abnormal system power breaking.

### BACKGROUND OF THE INVENTION

1. Field of the Invention

The present invention relates to a method for increasing reliability of data accessing for a multi-level cell type non-volatile memory, and more particularly to a method by which specific data storage pages are selected and stored at least in a data storage block by jump connecting of a page jumper during data accessing of a computer system, thus the life of use of the memory can be elongated to assure integrity of the data in accessing.

2. Description of the Prior Art

NAND flash memories have the characteristics of little writing and erasing cycles, high density (large storage space) and low cost of manufacturing; by virtue that their I/O interfaces only allow continuous reading, they do not suit storing for computers, but do very much suit application on storage cards. Except storage cards which have been being used in large amount, cell phones, MP3 players and digital multi-medium players have also been being used in large amount as media for storing multi-medium files.

NAND flash memories are divided into two kinds of storing structures, i.e., the Single Level Cell (SLC) and Multi-level Cell (MLC). In the modes of using cells, an SLC flash memory is the same as an EEPROM, but the oxidized thin films in its floating gate and the source are thinner. After data writing into the SLC flash memory, by adding voltage to the electric charges of the floating gate, the electric charges stored can be erased through the source. With such mode, a data bit is stored (1 means erasing, 0 means writing). While an MLC flash memory uses electric charges of different levels in the floating gate, thereby a single transistor can be stored therein with information of multiple bits, and through the control of writing and sensing of the cells, the single transistor creates a multi-layer state.

Taking a 4 LC flash memory as an example, a cell includes two bits of which the smaller one is the least significant bit (LSB), while the larger one is the most significant bit (MSB) able to create a 4 layer state (00, 01, 11, 10) to be written into different pages of a block. Wherein, as shown in FIG. 6, the two bits (LSB, MSB) of each cell (Y0, Y1, Y2, . . . ) are written respectively in the LSB and MSB pages of the block. When in programming the Y0 bit of the LSB page, the voltage level of the cell will be changed to influence the Y0 bit of the MSB page. Similarly, in programming the Y0 bit of the MSB page, the Y0 bit of the LSB page will be changed as well.

In the process of data accessing, the computer system writes starting from the LSB page, and then continues on the MSB page. In writing in the MSB page, if an abnormal system power breaking is induced by abnormally plugging/unplugging or the phenomenon of exhausting of a battery, the MSB page and the data originally written in the LSB page will be damaged at the same time. Perhaps such a problem may have minor influence to a NAND flash memory during a 90 nm manufacturing process; however, following micro reducing of the manufacturing process, as is shown in FIG. 7A, after writing of the page 0 and page 1 of the LSB page in the structure of a 70 nm manufacturing process, writing of page 2 and page 3 of the MSB page will be followed closely; or as is shown in FIG. 7B, after writing of the page 0, page 1 and page 3 of the LSB page in the structure of a 50 nm manufacturing process, writing of pages 4, 5, 6 and page 7 of the MSB page will be followed closely. In this way, in the 50 nm manufacturing process, similarity of the data among pages 0-3, or among pages 4-7 will often have great differences, even there are different files, once an abnormal system power breaking is induced, it is subjected to creating damages and hard to remedy.

Additionally, for SLC and MLC flash memories, stability and complexity in storing 1 bit and multiple bits for cells of same capacity are different; an SLC flash memory is more stable than an MLC flash memory, and the speed of writing in the SLC flash memory is faster than that of the MLC flash memory. Although the MLC flash memory having multiple bits can increase storing capability, by an inherent physical limitation, theoretically, number of times of writing on the SLC flash memory is 100,000/block; the life of use of the SLC flash memory is ten times over that of the MLC flash memory having times of writing of only 10,000 times/block; i.e., the life of use of the MLC flash memory is shorter than that of the SLC flash memory.

In view of this, and for eliminating the above defects, the method for increasing reliability of data accessing for a multi-level cell type non-volatile memory not only can reduce the frequency of erasing of flash memory blocks to elongate the life of use of the multi-level cell type non-volatile memory, but also can assure integrity of the data in accessing. The inventor provided the present invention after studying and development without stopping and experience for many years.

### SUMMARY OF THE INVENTION

The primary object of the present invention is to provide a method for increasing reliability of data accessing for a multi-level cell type non-volatile memory, in which by a step wherein at least a set of data storage pages in corresponding to a physical page of a storage cell are selected when a page jumper jumps over another data storage page in corresponding to the physical page of the same storage cell to do accessing for at least a data storage block, reducing of the frequency of erasing of data storage blocks can be effected to elongate the life of use of the multi-level cell type non-volatile memory.

The secondary object of the present invention is to provide a method for increasing reliability of data accessing for a multi-level cell type non-volatile memory, in which by a step wherein several data storage blocks are used to respectively access data for a computer system, synchronic damaging of data in accessing and data accessed originally created because of the accessing characteristic of the multi-level cell type non-volatile memory can be avoided when an abnormal system power breaking is induced, this can assure integrity of the data in accessing.

To get the above stated objects of the present invention, the method for increasing reliability of data accessing for a multi-level cell type non-volatile memory provided in the present invention comprises the following steps:
a. to take a plurality of data storage blocks for data accessing of a computer system in accordance with the multi-level cell type non-volatile memory; and
b. to provide a page jumper to select at least a set of data storage pages in corresponding to a physical page of same storage cell and to do accessing for at least a data storage block by jump connecting of the page jumper which jumps over another data storage page in corresponding to the physical page of the same storage cell.

When in practicing, by jump connecting of the page jumper, one can select at least a set of data storage pages in corresponding to a physical page of a storage cell to do accessing for at least a data storage block; and by jump connecting of the page jumper which jumps over another data storage page in corresponding to the physical page of the same storage cell, one can do accessing for another data storage block without using the page jumper.

And there is another step in practicing: to merge the data storage blocks for accessing of the page jumper in a clean block, in order that a data storage block without the storage capacity of the page jumper□is formed, and the data in a plurality of data register blocks are erased.

And in practicing, the data storage block in accessing of the page jumper can be used as a data backup block of the data storage block being used in accessing of the computer system, and after data are checked to be no error, the data in the data backup block can be erased.

The present invention will be apparent after reading the detailed description of the preferred embodiment thereof in reference to the accompanying drawings.

### BRIEF DESCRIPTION OF THE DRAWINGS

FIG. 1 is a flow chart showing a preferred embodiment of the present invention;

FIG. 2 is a schematic block diagram of the preferred embodiment of the present invention;

FIG. 3 is a schematic block diagram showing actions in data storing of the preferred embodiment of the present invention;

FIG. 4 is a schematic block diagram of the present invention showing a page jumper keeping a bypass;

FIG. 5 is a schematic block diagram of another preferred embodiment of the present invention;

FIG. 6 is a schematic diagram showing a data storage skeleton of a 4LC flash memory of the present invention;

FIG. 7 is a schematic diagram of a data storage skeleton of a 4LC flash memory in a 70 nm manufacturing process;

FIG. 7B is a schematic diagram of a data storage skeleton of a 4LC flash memory in a 50 nm manufacturing process;

FIG. 8 is a schematic diagram of a data storage skeleton of a conventional 8LC flash memory.

### DETAILED DESCRIPTION OF THE PREFERRED EMBODIMENT

As a person skilled in the art can know, any multi-level cell type (MLC) non-volatile memory is formed by combination in arrays, any storage cell has n bits, and the MLC non-volatile memory is divided into a plurality of data storage blocks, each data storage block is further divided into a plurality of data storage pages. The data storage blocks each is a minimum unit for executing data erasing; while each data storage page is a minimum unit for executing data programming.

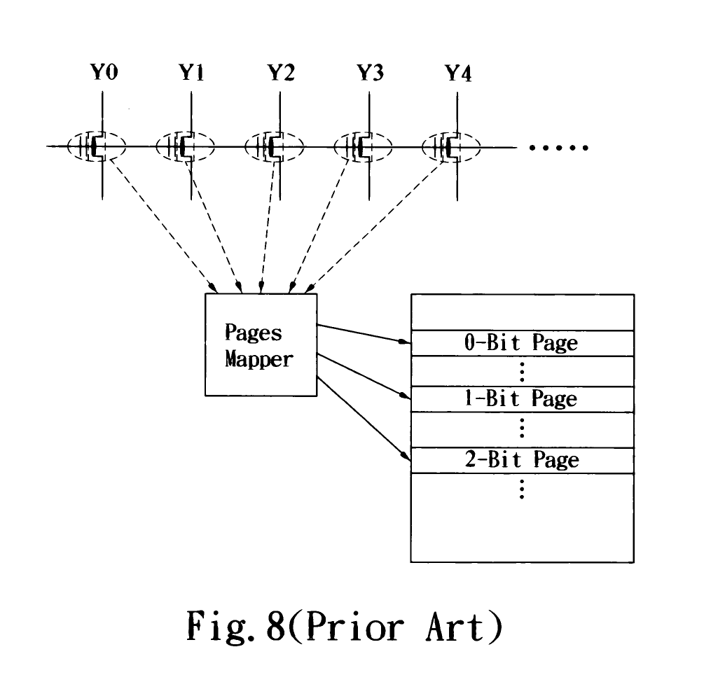

Taking an 8LC (Level Cell) non-volatile memory as an example, generally speaking and as shown in FIG. 8, any storage cell (Y0, Y1 . . . ) of the MLC non-volatile memory has 3 bits (0, 1, 2 bits). In accessing of a computer system, a logical address is mapped onto 3 physical addresses (0, 1, 2 bits) through a mapper, in order that a logical page is mapped onto 3 physical pages, and the (0, 1, 2 bits) of each storage cell respectively form a 0^{th} order bit page, a 1^{th} order bit page and a 2^{th} order bit page. Wherein, each data storage block of the 8LC (Level Cell) non-volatile memory includes 48 pages; as a person skilled in the art can know, the data storage blocks can also include any number of pages, that is dependent on the size of the non-volatile memory.

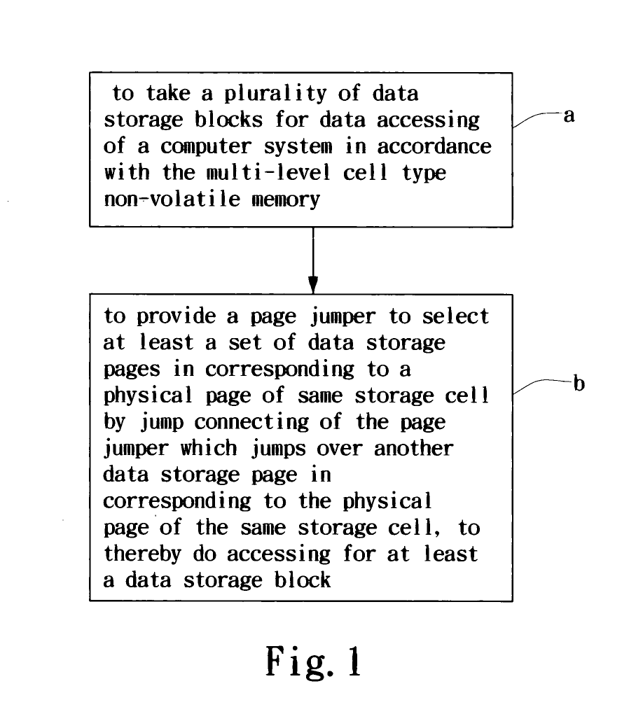

Referring to FIG. 1 showing a preferred embodiment of the method for increasing reliability of data accessing for a multi-level cell type non-volatile memory, it is used in the process of data accessing of a computer system for the data storage blocks. The method comprises the following steps:
a. to take a plurality of data storage blocks for data accessing of a computer system in accordance with the multi-level cell type non-volatile memory; and
b. to provide a page jumper to select at least a set of data storage pages in corresponding to a physical page of same storage cell and to do accessing for at least a data storage block by jump connecting of the page jumper which jumps over another data storage page in corresponding to the physical page of the same storage cell.

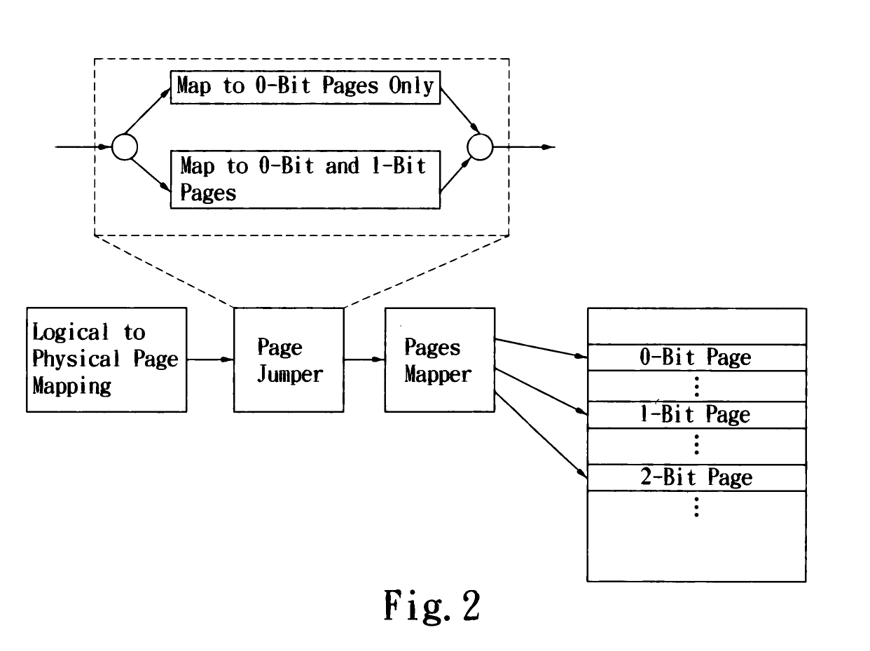

Referring to FIG. 2 which is a schematic block diagram of the preferred embodiment of the present invention, the page jumper is used in front of a page mapper, when a logical page is mapped onto a physical page, one can select at least a set of data storage pages in corresponding to the physical page of the same storage cell to do accessing for at least a data storage block; in order that a plurality of data storage blocks using the page jumper for accessing are used as the data register blocks of a logical data block in doing accessing for the computer system. In which, during the process of accessing of the computer system for a data storage block of the MLC non-volatile memory, the pages of the data storage block are substantially continuous. As a person skilled in the art can know, the data in the data storage block perform data programming for the data storage pages in the sequence of page addresses from the minimum to the maximum one.

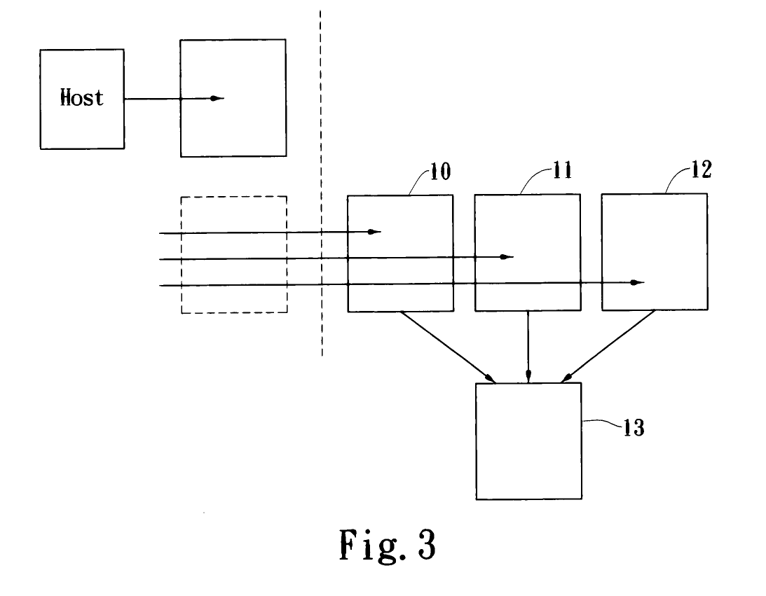

Please refer to FIGS. 2 and 3 simultaneously, the drawings take the 8LC (Level Cell) non-volatile memory as an example, in a step a. as of the present invention, 3 data storage blocks are taken as data register blocks (1, 10, 11) of the computer system; and in a step b., the page jumper is selected to map only onto the 0^{th} order bit page formed from the 0 bit among 3 bits of the same storage cell, and to respectively store in the 3 data register blocks (1, 10, 11). When the computer system writes the data on all the 48 pages, and after another data register block is changed for, an appropriate time is then looked for to merge the data of several data register blocks (1, 10, 11) into a clean block 2, thereby a data register block having no page jumping is formed, and the mapping direction is renewed, the data in these data register blocks (1, 10, 11) are erased. When in practicing, the data storage blocks (1, 10, 11) are clean blocks, but can also be blocks having stored with data; while the page jumper can also be selected at the same time for storing the 0^{th} order bit page and the 1^{th} order bit page formed from the 0 bit and the 1 bit mapped onto the same storage cell.

And when in practicing, the present invention can also be applied to various MLC non-volatile memories. Taking a 4LC (Level Cell) non-volatile memory as an example, any storage cell stores 2 bits, the page jumper only selects the LSB page formed from the least significant bit (LSB) of the 2 bits, rather than the MSB page formed from the most significant bit (MSB).

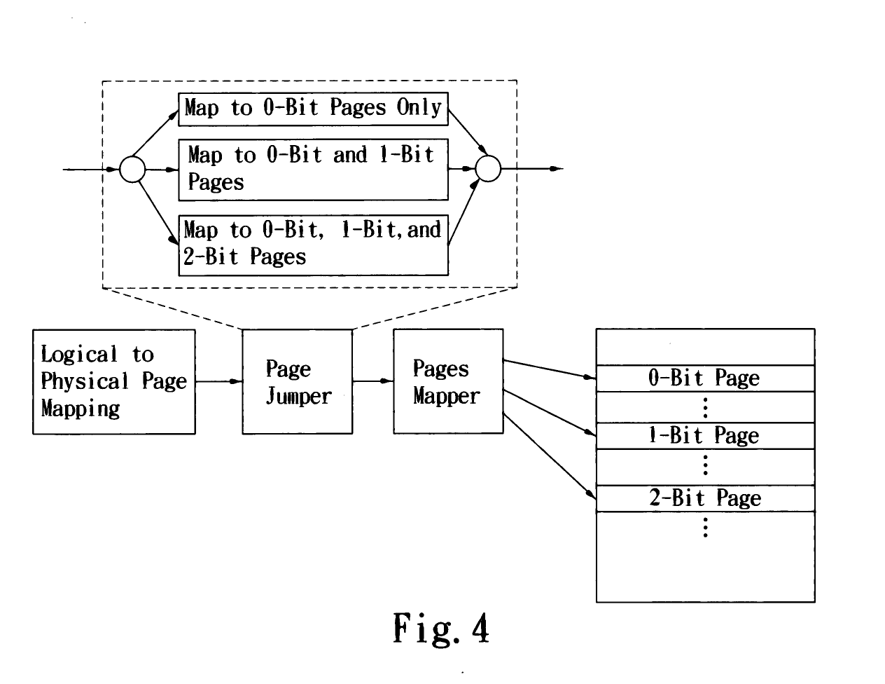

By the selection steps of the above page jumper, the data writing speed of the computer system can be increased, but the capacity of the data storage block is smaller. And as shown in FIG. 4, when the page jumper selects at least a set of data storage pages in mapping to a physical page of the same storage cell to do accessing for at least a data storage block, a bypass is kept; the bypass simultaneously maps onto the 0, 1 and 2^{th} order bit pages. When the page jumper does not select the bypass, namely, it skips over the data storage pages of the 0, 1 and 2^{th} order bit pages, the data storage pages can make access of the data of the computer system to another data storage block without using the page jumper, thus the capacity as that of the original data storage block can be obtained.

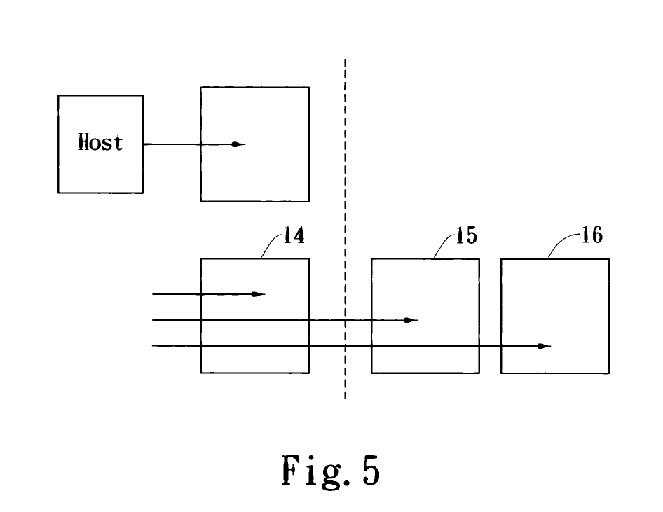

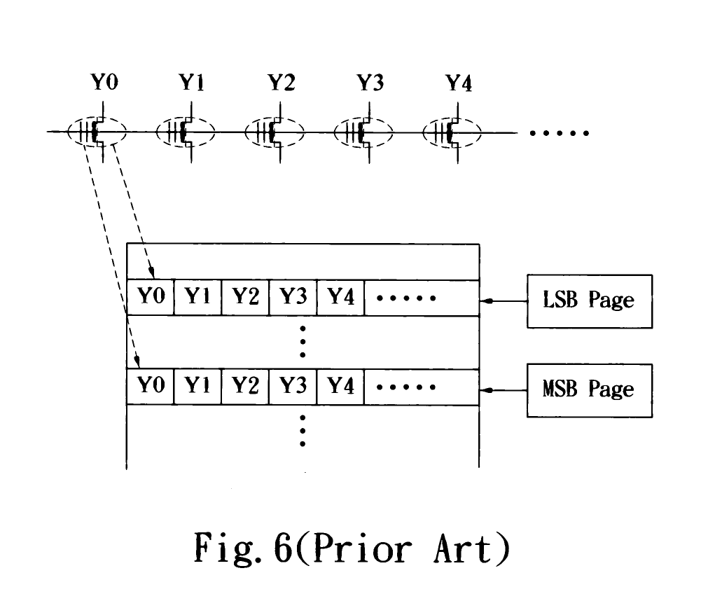

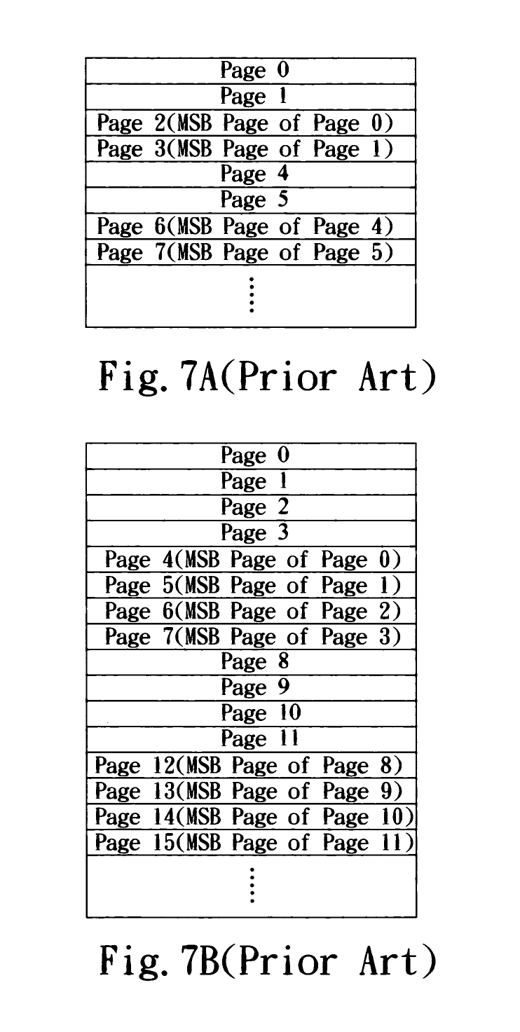

As shown in FIG. 5 which shows another preferred embodiment of the present invention, in which, the data storage block using the page jumper for accessing is used as a data backup block of the data storage block in doing accessing for the computer system. Taking an 8LC (Level Cell) non-volatile memory as an example, when the computer system is in doing data programming for the data storage pages in the sequence of page addresses from the minimum to the maximum one, it takes 3 data storage blocks (14, 15, 16) of which the data storage block 14 includes all the data of the 0, 1 and 2^{th} order bit pages that the computer system is in accessing, while the other two data storage blocks (15, 16) respectively back up the data of the 0 and 1^{th} order bit pages through jump connecting of the page jumper.

Thereby when the data that the computer system is accessing onto the data storage block 14 are wrong, one can read the corresponding data storage pages in the two data storage blocks (15, 16) for backing up to obtain correct data. And after the computer system changes the data storage block in accessing, it waits for an appropriate time to erase the data in the data backup block. Further, before the erasing of the data in the data backup block, the data in the data storage block 14 when the computer system is accessing are verified to assure their correctness.

Therefore, the present invention has the following advantages:
1. The page jumper provided in the present invention is selectable, namely, one can select the fastest programming speed and a 0^{th} order bit page or an LSB page with the best reliability, and renders the normally used data storage block to only use the LSB page, in order to reduce the frequency of erasing of the data storage block, thereby the life of use of the data storage block can be elongated, and the life of use of the multi-level cell type non-volatile memory can be elongated too.
2. By jump connecting of a page jumper, the data that the computer system is accessing continuously are stored in the data register blocks, and then are merged in a data storage block having integrity of data. Therefore, potentially damaging of data in accessing and data accessed originally during accessing of the MLC non-volatile memory can be avoided when an abnormal system power breaking is induced, this can assure integrity of the data in accessing.

In conclusion, according to the description disclosed above, the present invention surely can get the expected object thereof to provide a method for increasing reliability of data accessing for a multi-level cell type non-volatile memory, this not only can reduce the frequency of erasing of flash memory blocks to elongate the life of use of the multi-level cell type non-volatile memory, but also can assure integrity of the data in accessing.

While the embodiments given are only for illustrating the technical measures of the present invention; it will be apparent to those skilled in this art that various equivalent modifications or changes without departing from the spirit of this invention shall also fall within the scope of the appended claims.

Having thus described the technical process of my invention having high industrial value, what I claim as new and desire to be secured by Letters Patent of the United States is:

1. A method for increasing reliability of data accessing for a multi-level cell type non-volatile memory being used in a process of data accessing of a computer system for data storage blocks, wherein said multi-level cell type non-volatile memory includes a plurality of multi-level storage cells which are divided into a plurality of data storage blocks, each of said data storage blocks includes a plurality of data storage pages: said method comprises following steps:
a. to take a plurality of data storage blocks for data accessing of said computer system in accordance with said multi-level cell type non-volatile memory; and
b. to provide a page jumper to select at least a set of data storage pages in corresponding to a physical page of same storage cell and to do accessing for at least one of said data storage blocks by jump connecting of said page jumper which jumps over another data storage page in corresponding to said physical page of said same storage cell.

2. The method as in claim 1, wherein
said method comprises another step: to merge said data storage blocks for accessing of said page jumper in a clean block, in order that a data storage block without storage capacity of said page jumper is formed.

3. The method as in claim 1, wherein
one of said data storage blocks in accessing of said page jumper is used as a data backup block of said data storage block being used in accessing of said computer system, and when data that said computer system is accessing onto said data storage block are wrong, corresponding ones of said data storage pages in said data storage blocks are read to obtain correct data; and when said computer system changes said data storage block in accessing, data in said data backup block are erased.

4. The method as in claim 3, wherein
before erasing of said data in said data backup block, said data in said data storage block are verified to assure their correctness when said computer system is accessing.

5. The method as in claim 1, wherein
said data storage blocks using said page jumper for accessing are used as data register blocks of a logical data storage block in doing accessing for said computer system; after one of the said data register blocks in accessing is changed by said computer system, data of several of said several data register blocks are merged into a clean block, thereby a data register block having no page jumping is formed, and data in said several data register blocks are erased.

6. The method as in claim 1, wherein
data in said data storage block in accessing performs data programming for said data storage pages in a sequence of page addresses from minimum to maximum one.

7. The method as in claim 1, wherein
among said multi-level storage cells included in said multi-level cell type non-volatile memory, any of said storage cell stores n bits, said page jumper only selects an LSB page formed from said n bits.

8. A method for increasing reliability of data accessing for a multi-level cell type non-volatile memory being used in a process of data accessing of a computer system for data storage blocks, said method comprises the following steps:
a. to take a plurality of data storage blocks for data accessing of a computer system in accordance with the multi-level cell type non-volatile memory; and
b. to provide a page jumper to select at least a set of data storage pages in corresponding to a physical page of a storage cell to do accessing for at least a data storage block, and to jump over another data storage page in corresponding to said physical page of said same storage cell, said data storage pages thus access data for another data storage block without using said page jumper.

9. The method as in claim 8, wherein
said method comprises another step: to merge said data storage blocks for accessing of said page jumper in a clean block, in order that a data storage block without storage capacity of said page jumper is formed.

10. The method as in claim 8, wherein
one of said data storage blocks in accessing of said page jumper is used as a data backup block of said data storage block being used in accessing of said computer system, and when data that said computer system is accessing onto said data storage block are wrong, corresponding ones of said data storage pages in said data storage blocks are read to obtain correct data; and when said computer system changes said data storage block in accessing, data in said data backup block are checked to be no error and are erased.

11. The method as in claim 10, wherein
before erasing of said data in said data backup block, said data in said data storage block are verified to assure their correctness when said computer system is accessing.

12. The method as in claim 8, wherein
said data storage blocks using said page jumper for accessing are used as data register blocks of a logical data storage block in doing accessing for said computer system; after one of said data register blocks in accessing is changed by said computer system, data of several of said several data register blocks are merged into a clean block, thereby a data register block having no page jumping is formed, and data in said several data register blocks are erased.

13. The method as in claim 8, wherein
data in said data storage block in accessing performs data programming for said data storage pages in a sequence of page addresses from minimum to maximum one.

14. The method as in claim 8, wherein
among said multi-level storage cells included in said multi-level cell type non-volatile memory, any of said storage cell stores n bits, said page jumper only selects an LSB page formed from said n bits.
